(19) United States
(12) Patent Application Publication
(10) Pub. No.: US 2012/0169021 A1
(43) Pub. Date: Jul. 5, 2012

(54) CHASSIS FOR TWO-SEAT CHILDREN'S PUSHCHAIRS

(75) Inventor: Manuel JANE SANTAMARIA, Palau de Plegamans (ES)

(73) Assignee: Jane, S.A., Palau de Plegamans (ES)

(21) Appl. No.: 13/337,852

(22) Filed: Dec. 27, 2011

(30) Foreign Application Priority Data
Jan. 3, 2011 (ES) 201130002

(51) Int. Cl. B62B 3/00

(52) U.S. Cl. 280/47.35

(57) ABSTRACT

A chassis for two-seat children's pushchairs. The chassis includes front and rear legs with wheels and a handle. Each side of the chassis presents a coupling for two supports at different heights for separable assembly of the two seats, with the upper support in a forward position and the lower support in a rear position. The upper support is coupled in an inclined manner towards the front in the core where the handle, front and rear legs and the lower are articulately coupled and the lower support coupled to the rear leg.

This application claims benefit of Serial No. 201130002, filed 3 Jan. 2011 in Spain and which application is incorporated herein by reference. To the extent appropriate, a claim of priority is made to each of the above disclosed applications.

### BACKGROUND TO THE INVENTION

Two-seat children's pushchairs for twins have been known for many years and which present a special chassis for holding the two children. These pushchairs generally comprise two side-by-side seats and, because of the width, they can be difficult to manoeuvre through a normal-size door. Pushchairs are also used in which the seats are arranged one behind the other. In both cases, the seats may be replaced by a car-seat or carry-cot.

All these pushchairs present a larger chassis than an ordinary pushchair and are more complicated to fold and it is difficult to put them into the boot of a standard car.

### SUMMARY OF THE INVENTION

The objective of this invention is a chassis for two-seat children's pushchairs that have several advantages over those currently known. One of these advantages is that the chassis is the normal type that comprises a seat and the second advantage is that the chassis is prepared for installing a second seat when required.

This enables two children to be placed in the pushchair or only one and install a second seat in the pushchair when required.

These advantages are achieved by having two supports at different heights on each side of the chassis for separable installation of the two seats, with the upper support in a forward position and the lower support in a rear position.

Preferably, this chassis shall be the type comprising front and rear legs with wheels and a handle and where the upper support coupled in an inclined manner towards the front in the core where they are articulately coupled to the handle, front and rear legs and the lower support is coupled to the rear leg.

Because the seat mounted on the lower supports is very low, wheel protectors are installed on the chassis between the rear wheels to prevent the child accidently touching the wheels.

These and other characteristics are better understood in the following description which, in order to facilitate this understanding, is accompanied by two sheets of drawings that represent a practical embodiment that is cited as a non-limiting example of the scope of this invention.

### DESCRIPTION OF THE DRAWINGS

In the drawings,

FIGS. 1 and 2 illustrate the chassis covered by this invention and seen in front perspective and side elevation respectively; and

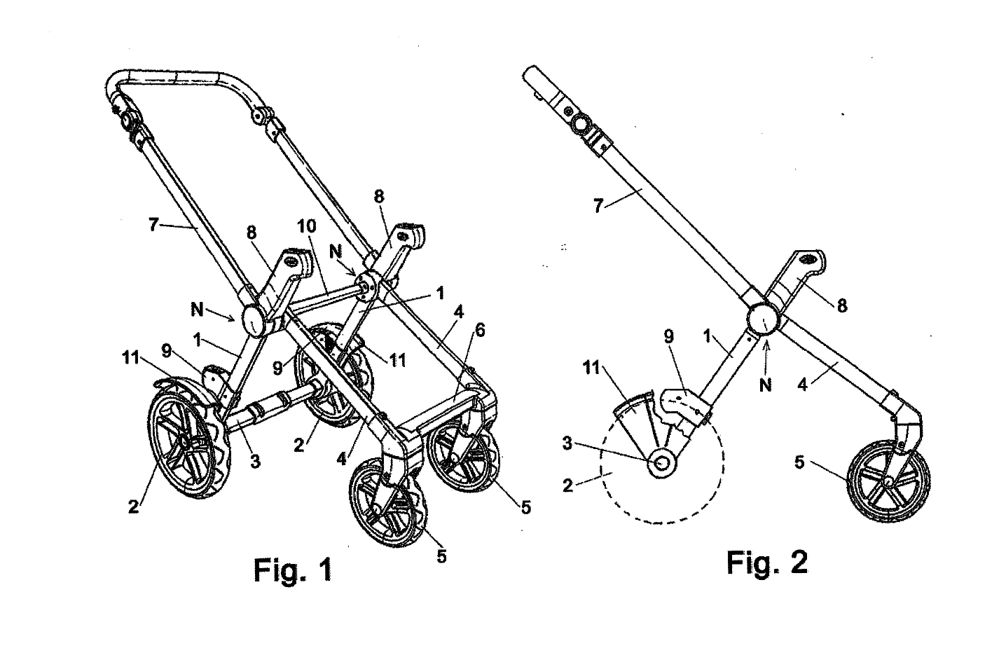

FIGS. 3 and 4 respectively show this chassis fitted with two seats in front and rear perspectives.

### DETAILED DESCRIPTION

In accordance with the drawings, the chassis for the two-seat children's pushchairs comprises two rear legs (1) with the corresponding wheels (2) that rotate on the transversal axle (3), two front legs (4) with the corresponding wheels (5) and joined together below with a cross member (6) and a handle (7) in an inverted “U” form.

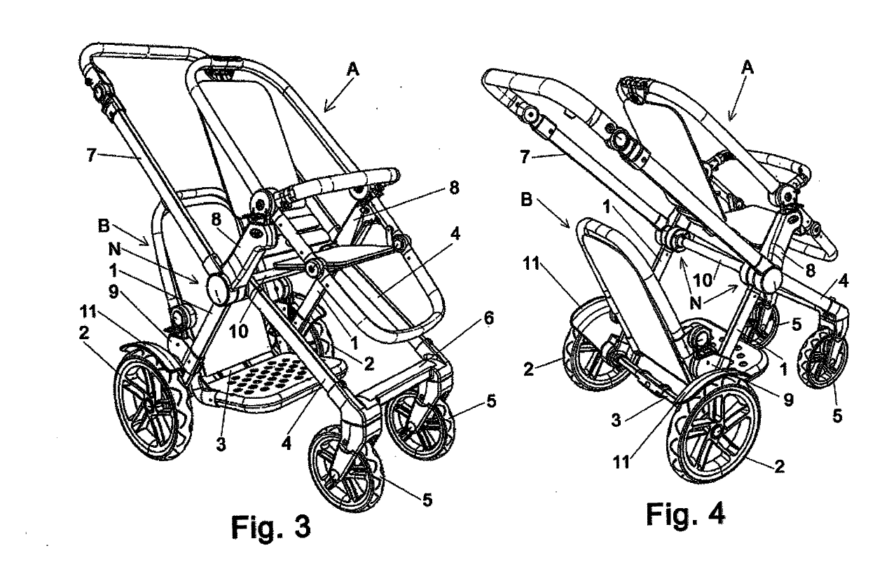

On each side the chassis presents the coupling of two supports (8 and 9) at different heights for separable installation of the two seats (A) and (B) (FIGS. 3 and 4) using conventional means or those of the applicant firm, with the upper supports (8) in an advanced position inclined forward and coupled to the cores (N), where they are articulately coupled to the handle (7), the front legs (4) and the rear legs (1), with the cores (N) joined together by a transversal shaft (10). The lower supports are fixed to the post-lower part of the rear legs (1).

As shown in FIGS. 3 and 4, the seat (B), coupled to the lower supports (9), is in a low position between the rear wheels (2). In order to prevent the child's hands coming into accidental contact with said wheels, protectors (11) are installed that are fitted facing the inside faces of the wheels and covering the upper parts.

The embodiment shown in FIGS. 3 and 4 is arranged so that the upper seat (A) is for a very young child and the lower seat (B) is for an older child, however, it should be taken into account that the supports (8 and 9), according to requirements, can be coupled, for example, to a car-seat, carry-cot or any other type of seat depending on the child's age.

As is logical, the represented seats are complete with upholstered elements and whatever accessories are considered necessary, for example, hoods.

The invention, within its essential character, may be put into practice in other embodiment forms that only differ in certain details from that indicated solely as an example and which similarly attain the claimed protection. This chassis for two-seat children's pushchairs may be manufactured in any form and size with the most suitable means and materials and with the most suitable accessories, with the component elements being replaced by their technical equivalents, so that everything is within the scope of the claims.

1. A chassis for two-seat children's pushchairs comprising front and rear legs with wheels and a handle; each side of the chassis including a coupling for two supports at different heights for separable assembly of the two seats, wherein the upper support being at a forward position and the lower support being at a rear position.

2. A chassis for two-seat children's pushchairs in accordance with claim 1, wherein the upper support is coupled in an inclined manner towards the front in a core where the handle, the front legs, the rear legs and the lower support are articulately coupled; and the lower support is coupled to the rear leg.

3. A chassis for two-seat children's pushchairs in accordance with claim 1, further comprising rear wheel protectors.
